(19) United States
(12) Patent Application Publication
(10) Pub. No.: US 2017/0352888 A1
(43) Pub. Date: Dec. 7, 2017

(54) REDOX TOLERANT ANODE COMPOSITIONS FOR FUEL CELLS

(71) Applicant: LG Fuel Cell Systems Inc., North Canton, OH (US)

(72) Inventors: Shung Ik Lee, Canton, OH (US); Minjae Jung, Stow, OH (US); Younghee Cho, North Canton, OH (US); Zhien Liu, Canton, OH (US)

(73) Assignee: LG Fuel Cell Systems Inc., North Canton, OH (US)

(21) Appl. No.: 15/175,948

(22) Filed: Jun. 7, 2016

(51) Int. Cl. H01M 4/86; H01M 4/90

(52) U.S. Cl. CPC H01M 4/8652; H01M 4/9033

(57) ABSTRACT

In accordance with some embodiments of the present disclosure, a method of changing the porosity of the anode is presented. The anode is formed from a composition comprising nickel oxide, a doped ceria, and a stabilized zirconia wherein the weight percentage of the nickel oxide is greater than twenty-five percent. The anode may comprise a single or multiple layers, and may comprise at least one of gadolinia doped ceria (GDC), samaria doped ceria (SDC), or lanthania doped ceria (LDC); and at least one of Yttria stabilized zirconia (YSZ) or scandia stabilized zirconia (ScSZ). The anode may comprise multiple layers. Each layer may comprise a composition having the general formula NiOₓ-(doped ceria)_{y} wherein x and y are weight percentages of the composition, and wherein 25<x<100, and 25<y<100, and wherein each successive layer contains more nickel than the preceding layers.

This invention was made with Government support under Assistance Agreement No. DE-FE0012077 awarded by Department of Energy. The Government has certain rights in this invention.

### FIELD

This disclosure generally relates to fuel cells. More specifically, this disclosure is related to redox tolerant anode compositions for fuel cells.

### BACKGROUND

A fuel cell is an electrochemical system in which a fuel (such as hydrogen) is reacted with an oxidant (such as oxygen) at high temperature to generate electricity. One type of fuel cell is the solid oxide fuel cell. The basic components of a solid oxide fuel cell may include an anode, a cathode, an electrolyte, and an interconnect which provides the electrical connection between individual cells. The anode may be a mixed cermet comprising nickel and zirconia (such as, e.g., yttria stabilized zirconia (YSZ)) or nickel and ceria (such as, e.g., gadolinia dope ceria (GDC)). However, nickel is susceptible to oxidation if a high pO2 is introduced to the anode side of a fuel cell. The oxidation of nickel produces NiO and may cause a volume change in the components of the anode, thereby introducing undesirable stresses into the fuel cell components. In turn, these stresses can cause damage to the cell microstructure and reduce the performance of the fuel cell. In the worst case scenario, the fuel cell may break leading to a catastrophic failure of the fuel cell system.

The damage that may be caused by the oxidation of nickel is dependent on cell design. In an anode-supported fuel cell system, just one redox cycle may damage the fuel cell. While other designs, such as a segment-in-series or in-plane series fuel cell that use thin layers attached to an inert support, may be less susceptible to volume-change induced stress, these designs may still suffer a reduction in fuel cell performance and eventual failure after repeated redox cycles.

Many fuel cell systems include an anode protection system to prevent nickel oxidation. However, these systems add cost and complexity to the manufacturing, installation, and operation of fuel cell systems. Additionally, such systems may provide inadequate protection against anode oxidation if the fuel system fails during fuel cell operation.

There remains a need for anodes having greater redox tolerance to prevent or eliminate the potentially catastrophic consequences of nickel oxidation.

### SUMMARY

Example compositions for the anode of a fuel cell, such as, e.g., a solid oxide fuel cell, are described herein which exhibit improved redox tolerance. In accordance with some embodiments, the porosity of the anode is controlled through the deliberate selection of materials from which the anode is comprised. The anode may be of a single or multi-layered design wherein each layer may comprise a composition that is different from the composition of one or more other layers. The particular composition of an anode or an anode layer may be selected to balance the electronic conductivity, porosity, or other characteristics needed of that layer to perform its designed function. The materials may be in a powder form and may be mixed together before firing.

In accordance with some embodiments of the present disclosure, a method of changing the porosity of the anode is presented. The anode is formed from a composition comprising nickel oxide, a doped ceria, and a stabilized zirconia wherein the weight percentage of the nickel oxide is greater than twenty-five percent. The anode may comprise a single or multiple layers, and may comprise at least one of gadolinia doped ceria (GDC), samaria doped ceria (SDC), or lanthania doped ceria (LDC); and at least one of Yttria stabilized zirconia (YSZ) or scandia stabilized zirconia (ScSZ).

In accordance with some embodiments of the present disclosure, a fuel cell is presented. The fuel cell may comprise an anode, a cathode, and an electrolyte disposed between said anode and said cathode, the anode comprising a composition having the general formula NiOₓ-(doped ceria)_{y}-(stabilized zirconia)_{z} wherein x, y, and z are weight percentages of the composition, and wherein 25<x<100, 25<y<100, and 0<z=1−x−y.

In accordance with some embodiments of the present disclosure, a fuel cell is presented. The fuel cell may comprise an anode, a cathode, and an electrolyte disposed between said anode and said cathode. The anode may comprise a first layer disposed between a second layer and said electrolyte. The first layer may comprise a composition having the general formula NiOₓ-(doped ceria)_{y} wherein x and y are weight percentages of the composition, and wherein 25<x<100, and 25<y<100. The second layer may comprise a composition having the general formula NiOₓ-(doped ceria)_{y}-(stabilized zirconia)_{z}, wherein x, y, and z are weight percentages of the composition, and wherein 25<x<100, 25<y<100, and 0<z=1−x−y.

In accordance with some embodiments of the present disclosure, a fuel cell is presented. The fuel cell may comprise an anode, a cathode, and an electrolyte disposed between said anode and said cathode. The anode may comprise a first layer, a second layer, and a third layer, said first layer being disposed between said second layer and said electrolyte, and said second layer being disposed between said first layer and said third layer. Each layer may comprise a composition having the general formula NiOₓ-(doped ceria)_{y} wherein x and y are weight percentages of the composition, and wherein 25<x<100, and 25<y<100, and wherein each successive layer contains more nickel than the preceding layers.

These and many other advantages of the present subject matter will be readily apparent to one skilled in the art to which the disclosure pertains from a perusal of the claims, the appended drawings, and the following detail description of the embodiments.

### BRIEF DESCRIPTION OF THE DRAWINGS

FIG. 1 shows a cross-section of a fuel cell in accordance with some embodiments of the present disclosure.

FIG. 2 shows the porosity of a few examples of anode compositions in accordance with some embodiments of the present disclosure.

FIG. 3 shows conductivity test results for two anode compositions after multiple redox cycles.

FIG. 4 shows fuel cell ASR as a function of anode conductivity.

FIG. 5 shows the conductivity of an anode composition after successive redox cycles in accordance with some embodiments of the present disclosure.

Referring to the drawings, some aspects of a non-limiting example of a fuel cell system in accordance with an embodiment of the present disclosure is schematically depicted. In the drawing, various features, components and interrelationships therebetween of aspects of an embodiment of the present disclosure are depicted. However, the present disclosure is not limited to the particular embodiments presented and the components, features and interrelationships therebetween as are illustrated in the drawings and described herein.

### DETAILED DESCRIPTION

The objectives and advantages of the claimed subject matter will become apparent from the following detailed description of preferred embodiments thereof in connection with the accompanying drawings.

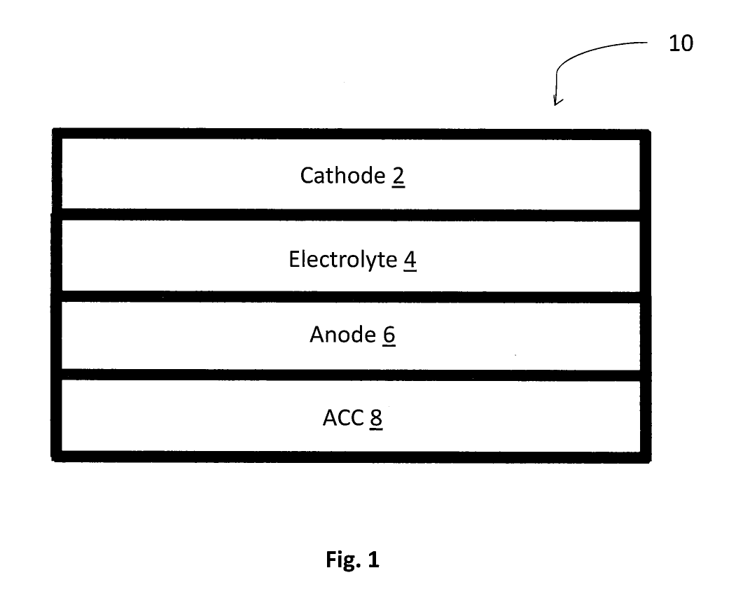

A cross-section of a fuel cell in accordance with some embodiments of the present disclosure is shown in FIG. 1. The fuel cell 10 comprises a cathode 2, an electrolyte 4, an anode 6, and an anode current collector 8. In some embodiments, the fuel cell 10 may comprise further layers (not shown) such as an interconnect, porous anode barrier, ceramic seal, chemical barrier, and cathode current collector. The combined functions of the anode 6 and anode current collector (ACC) 8 may be considered to perform the traditional anode function (e.g., the chemical combination of the fuel and the oxidant and the transportation of electrons away from the triple phase boundary). As used herein, “anode” refers to a layer or combination of layers that perform these traditional anode functions, unless reference is made to a specific layer of an anode. Each of the anode 6 and anode current collector 8 may be optimized to perform its designed function through selection of the location of the component and that location relative to other fuel cell components, and the structure and material composition of each. However, some embodiments are not limited to two combined layers which perform the anode function, but may comprise any number of layers. Some embodiments use a single layer to perform the anode function.

The anode 6, anode current collector 8, or both typically comprise a nickel or nickel-metal alloy, and may further comprise an ionic phase such as a stabilized zirconia or a doped ceria oxide. The stabilized zirconia may include yttria stabilized zirconia (YSZ) and scandia stabilized zirconia (ScSZ), and the doped ceria oxide may include GDC (gadolinia doped ceria).

The inventors of the present disclosure have discovered that the porosity of the anode plays a significant role in controlling the microstructure stresses caused by the oxidation of nickel. Consequently, controlling the porosity of the anode is an effective way of improving the redox tolerance of the fuel cell. In one aspect of the disclosure, the inventors have discovered that the anode composition can be selected to control the porosity of an anode.

In accordance with some embodiments, an anode composition is provided. The anode may be formed from a composition comprising a nickel or nickel-metal alloy, an ionic phase, and a pore-controlling phase which may be a second ionic phase. The materials from which the anode is comprised may be mixed when in a powder form before the mixture is fired to form the composite anode. The ionic phase may comprise a stabilized zirconia such as yttria stabilized zirconia (YSZ), scandia stabilized zirconia (ScSZ), or other stabilized zirconia. The pore-controlling phase may comprise a doped ceria oxide such as gadolinia doped ceria (GDC), samaria doped ceria (SDC), lanthania doped ceria (LDC), or other rare earth element doped ceria. Even though the nickel may be oxidized in these compositions, the combination of the doped ceria and stabilized zirconia may create an anode structure that can accommodate the volumetric increase of the anode caused by the formation of NiO, thereby improving the redox tolerance of the fuel cell.

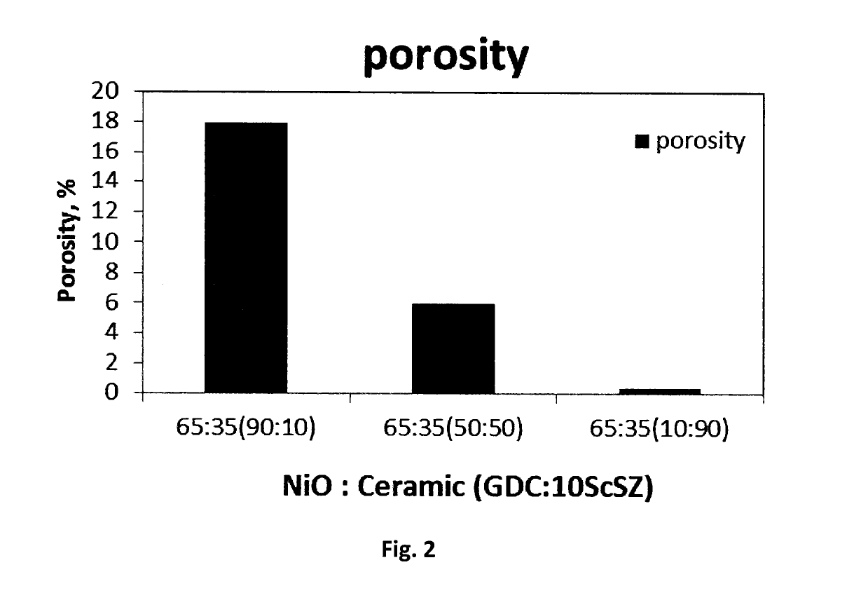

More particularly, the porosity of an anode or anode layer may be controlled by selecting the weight percentage of each component of the compositions described herein. FIG. 2 illustrates the measured porosity of a few examples of anode compositions in accordance with some embodiments of the present disclosure. Each example anode composition comprised NiO and a ceramic, wherein the ceramic comprised GDC and 10 ScSZ. For each sample, NiO comprised 65 wt % of the anode and the ceramic 35 wt %. Of the ceramic component, the first sample comprised a wt % ratio of GDC to 10 ScSZ of 90:10, the second sample comprised a wt % ratio of GDC to 10 ScSZ of 50:50, and the third sample comprised a wt % ratio of GDC to 10 ScSZ of 10:90. The addition of the GDC to the anode composition allowed control of the anode porosity from about 18% for the first sample, about 6% for the second sample, and to about 0.5% for the third sample. As demonstrated by FIG. 2, the porosity of the anode and to be effectively controlled by varying the mixing ratio of the two ionic components of the anode composition with more precision and over a wider range of porosities than available by other pore forming techniques.

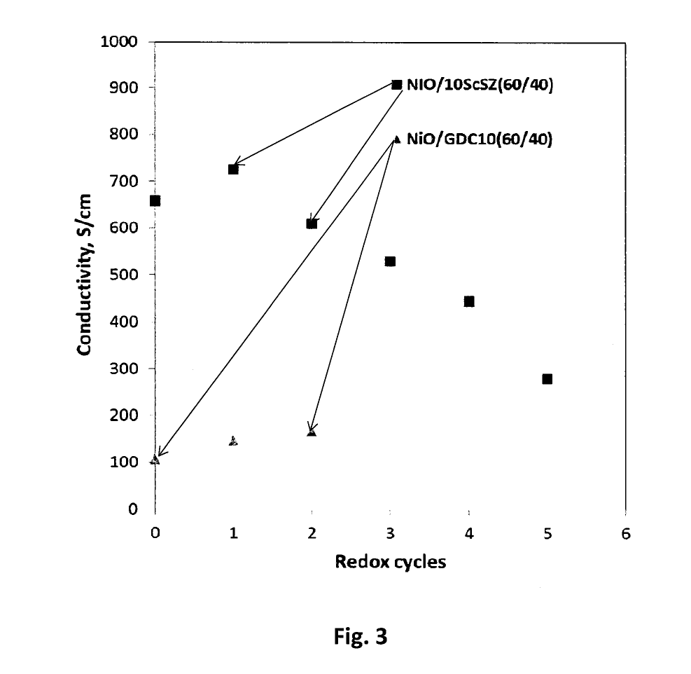

The porosity of an anode affects both the redox tolerance of the anode and the electrical conductivity of the anode. FIG. 3 shows strip conductivity test results of a NiO-10 ScSZ (60-40 wt %), and a NiO-GDC (60-40 wt %) composition anode after multiple redox cycles. As can be seen, the NiO-10 ScSZ anode has an initial conductivity of about 650 S/cm and its conductivity peaked after one redox cycle at greater than 700 S/cm. However, the conductivity of the NiO—ScSZ anode decreased rapidly after successive redox cycles. The initial conductivity of the Ni-GDC anode was about 100 S/cm. After two redox cycles, the Ni-GDC anode conductivity increased to about 175 S/cm. Post-testing analysis of the compositions revealed that the NiO-ScSZ anode had a dense microstructure whereas the Ni-GDC anode showed high porosity and low conductivity even with a high nickel wt % (60 wt %). The NiO-10 ScSZ anode suffered deteriorating conductivity due to its denser microstructure that could not accommodate the volumetric increase of the oxidized nickel, leading to severe damage to the anode microstructure. Conversely, the higher porosity of the Ni-GDC anode accommodated for this volumetric increase, but limited the overall conductivity of the anode.

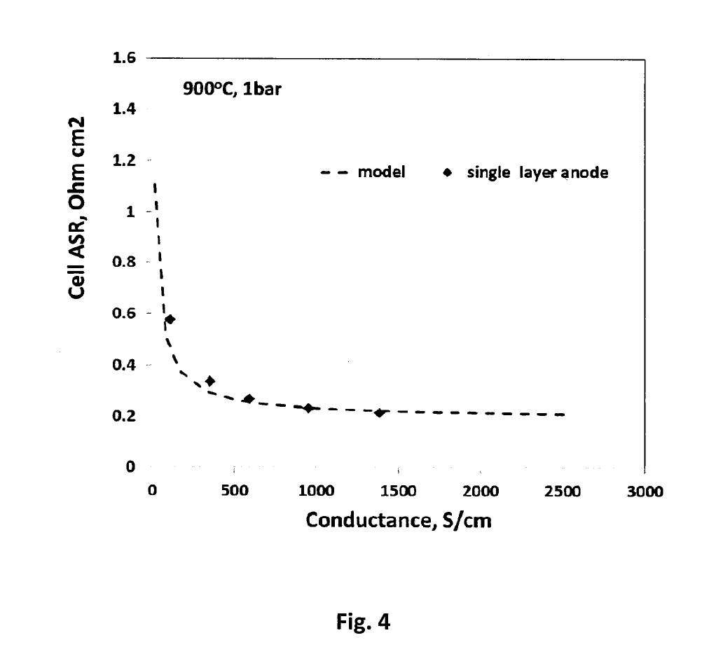

Electrical conductivity is a significant parameter of fuel cell performance, particularly for an in-plane series cell structures due to the in-plane electron conduction. FIG. 4 illustrates the effect on cell ASR of anode conductivity. As shown, cell ASR increases rapidly when the anode conductance is less than 300 S/cm. As described above, anode conductivity is affected by the cell porosity.

In accordance with some embodiments of the present disclosure, an anode composition for increased redox tolerance is provided. This embodiment may employ a single layer anode that performs the aforementioned anode functions. The anode composition may comprise NiOx, doped ceria, and stabilized zirconia having the general formula NiOₓ-(doped ceria)_{y}-(stabilized zirconia)_{z}, were 25 wt %<x<100 wt %, 0 wt % <y<100 wt %, and 0<z =1−x−y. The dope ceria and stabilized zirconia may comprise the compositions described above. The nickel content is selected to provide an active three phase boundary and to give conductivity to the anode. Preferably, nickel comprises 50-70 wt % of the anode composition. In some embodiments, it is preferrable to have the doped ceria comprise 10-40 wt % of the anode. The optimum composition of the anode is dependent on powder size and the particular doping materials used to form the anode. In some embodiments x=65. In some embodiments y=31.5

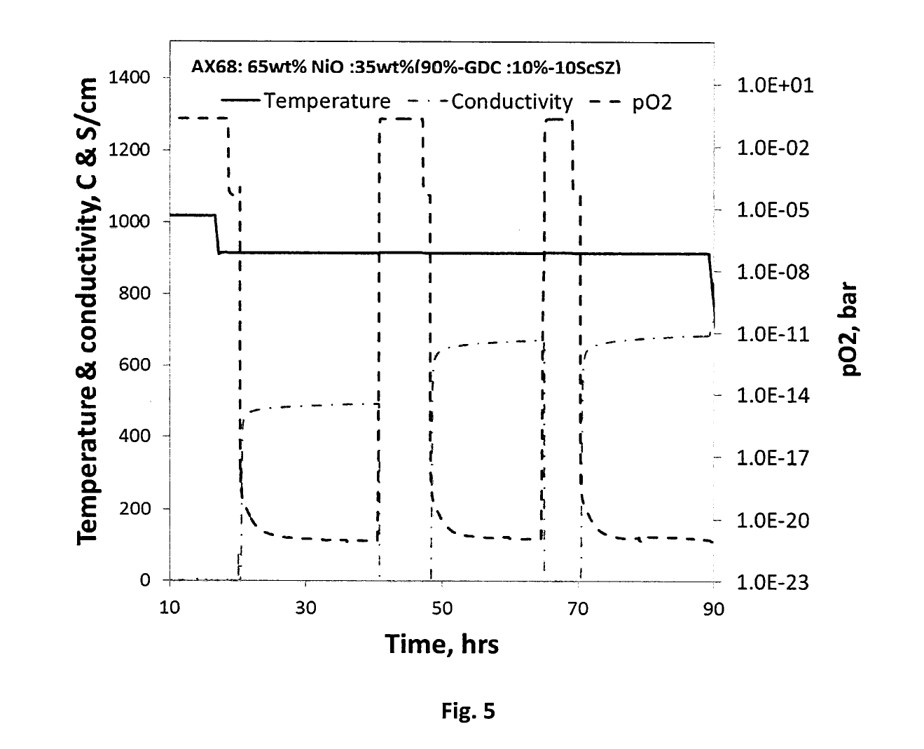

FIG. 5 illustrates an embodiment in accordance with the present disclosure of an anode composition that was subjected to successive redox cycles. The composition of the anode tested in FIG. 5 comprised NiO- ceramic in a ratio of 65-35 wt %, wherein the ceramic comprised 90 wt % GDC and 10 wt % ScSZ. The anode was subjected to two redox cycles (labeled 1 and 2) after each of which the conductivity of the anode was measured. The initial conductivity of the anode was about 500 S/cm. This conductivity rose to about 650 S/cm after the first redox cycle. Finally, the second redox cycle lead to an increase to about 700 S/cm. This level of conductivity is sufficient high for fuel cell operations, and the increasing conductivity demonstrates the increased redox tolerance of this anode composition.

In accordance with some embodiments of the present disclosure, an anode composition for increased redox tolerance is provided. The anode may comprise multiple layers that perform the anode functions described above. Additionally, the composition of each layer is selected to balance the redox tolerance, conductivity, and three phase boundary activity as need for the particular function of that layer. In some embodiments, the anode may comprise two layers. The first layer may be disposed next to the electrolyte and may have a composition selected to optimize the three phase boundary formation and have a higher porosity for increased redox tolerance. In some embodiments, the first layer may comprise Ni-GDC without zirconia for higher porosity, and may have a general formula NiOₓ-GDC_{y}, wherein 25 wt %<x<100 wt %, and 25 wt %<y<100 wt %. The second layer may primarily support electrical conduction and may contain higher nickel content, and may have a general formula NiOₓ-GDC_{y}-(YSZ or ScSZ)_{z}, wherein 25 wt %<x<100 wt %, 25 wt %<y<100 wt %., and 0<z=1−x−y. In some embodiments, the first layer is not limited to Ni-GDC. In some embodiments, the anode my comprise successive layers to the first and second layers wherein the successive layers may follow the general formulas given above with increasing nickel content as the distance between the layer and the electrolyte is increased.

In some embodiments, the anode may comprise greater than two layers. The first layer may be disposed by the electrolyte and may have a general formula of NiOₓ₁-GDC_{y}-(YSZ or ScSZ)_{z}, wherein 25 wt %<x1<100 wt %, 25 wt %<y<100 wt %, and 0<z=1−x1−y. The second layer may be disposed with the first layer between the second layer and the electrolyte and may have the general formula NiOₓ2-GDC_{y}-(YSZ or ScSZ)_{z}, wherein 25 wt %<x2<100 wt %, 25 wt %<y<100 wt %, and 0<z=1−x2−y wherein x1<x2. A third layer may be disposed with the second and first layers between the third layer and the electrolyte and may have the general formula NiOₓ3-GDC_{y}-(YSZ or ScSZ)_{z}, wherein 25 wt %<x3<100 wt %, 25 wt %<y<100 wt %, and 0<z=1−x3−y wherein x2<x3. Successive layers may follow the general formulas given above with increasing nickel content as the distance between the layer and the electrolyte is increased.

As disclosed herein, the composition of the anode can be selected to control the porosity of anode to increase redox tolerance while providing sufficient conductivity for fuel cell operation. The techniques disclosed herein provide better control of anode porosity over a wider range of porosities than other techniques. Increasing the redox tolerance of the anode by selecting the appropriate composition to control porosity allows simplification of the manufacturing and operation of the fuel cell and supporting systems.

While preferred embodiments of the present subject matter have been described, it is to be understood that the embodiments described are illustrative only and that the scope of the subject matter is to be defined solely by the appended claims when accorded a full range of equivalence, many variations and modifications naturally occurring to those of skill in the art from a perusal hereof.

We claim:

1. In a fuel cell having an anode comprising nickel oxide, a method of changing the porosity of the anode by forming the anode from a composition comprising nickel oxide, a doped ceria, and a stabilized zirconia wherein the weight percentage of the nickel oxide is greater than twenty-five percent.

2. The method of claim 1 comprising forming the anode as a single layer composition comprising at least one of gadolinia doped ceria (GDC), samaria doped ceria (SDC), or lanthania doped ceria (LDC); and at least one of Yttria stabilized zirconia (YSZ) or scandia stabilized zirconia (ScSZ).

3. The method of claim 2 comprising forming the anode from a composition comprising GDC.

4. The method of claim 1 comprising forming the anode as a multilayer anode wherein the composition of at least one layer comprises at least one of GDC, SDC, or LDC; and at least one of YSZ or ScSZ.

5. The method of claim 4 comprising forming the at least one layer from a composition comprising GDC.

6. The method of claim 1 comprising forming the anode in three layers from composition comprising nickel oxide, a doped ceria, and a stabilized zirconia, wherein the weight percentage of nickel oxide in a second layer disposed between a first layer and a third layer is greater than the weight percentage of nickel oxide in the first layer and less than the weight percentage of nickel oxide in the third layer.

7. A fuel cell comprising an anode, a cathode, and an electrolyte disposed between said anode and said cathode, said anode comprising a composition having the general formula:
NiOₓ-(doped ceria)_{y}-(stabilized zirconia)_{z}
wherein x, y, and z are weight percentages of the composition, and wherein:
25<x<100;
25<y<100; and
0<z=1−x−y.

8. The fuel cell of claim 7 wherein said anode comprises at least one of GDC, SDC, or LDC; and at least one of YSZ or ScSZ.

9. The fuel cell of claim 8 wherein said anode comprises GDC and ScSZ, and wherein x=65.

10. The fuel cell system of claim 9 wherein the anode comprises a composition wherein y=31.5.

11. A fuel cell comprising an anode, a cathode, and an electrolyte disposed between said anode and said cathode, said anode comprising a first layer disposed between a second layer and said electrolyte, said first layer comprising a composition having the general formula:
NiOₓ-(doped ceria)_{y}
wherein x and y are weight percentages of the composition, and wherein:
25<x<100; and
25<y<100,
and said second layer comprising a composition having the general formula:
NiOₓ-(doped ceria)_{y}-(stabilized zirconia),
wherein x, y, and z are weight percentages of the composition, and wherein:
25<x<100;
25<y<100; and
0<z=1−x−y.

12. The fuel cell of claim 11 wherein the doped ceria in the first layer of said anode comprises GDC.

13. The fuel cell of claim 12 wherein the doped ceria in the second layer of said anode comprises GDC, and wherein the stabilized zirconia in the second layer of said anode comprises YSZ or ScSZ.

14. A fuel cell comprising an anode, a cathode, and an electrolyte disposed between said anode and said cathode, said anode comprising a first layer, a second layer, and a third layer, said first layer being disposed between said second layer and said electrolyte, and said second layer being disposed between said first layer and said third layer, said first layer comprising a composition having the general formula:
NiOₓ₁-(doped ceria)_{y}-(stabilized zircona)_{z}
wherein x1, y, and z are weight percentages of the composition, and wherein:
25<x1<100;
25<y<100; and
0<z=1−x−y,
said second layer comprising a composition having the general formula:
NiOₓ₂-(doped ceria)_{y}-(stabilized zirconia)_{z}
wherein x, y, and z are weight percentages of the composition, and wherein:
x1<x2;
25<x2<100;
25<y<100; and
0<z=1−x−y,
and said third layer comprising a composition having the general formula:
NiOₓ₃-(doped ceria)_{y}-(stabilized zirconia)_{z}
wherein x3, y, and z are weight percentages of the composition, and wherein:
x2<x3;
25<x3<100;
25<y<100; and
0<z=1−x−y.

15. The fuel cell of claim 14 wherein the doped ceria in said first layer, said second layer, and said third layer comprises GDC.

16. The fuel cell of claim 15 wherein the stabilized zirconia in said first layer, said second layer, and said third layer comprises YSZ or ScSZ.

17. The fuel cell of claim 14 wherein the stabilized zirconia in said first layer, said second layer, and said third layer comprises YSZ or ScSZ.
